(19) United States
(12) Patent Application Publication
(10) Pub. No.: US 2022/0299245 A1
(43) Pub. Date: Sep. 22, 2022

(54) REFRIGERATOR

(71) Applicant: SAMSUNG ELECTRONICS CO., LTD., Suwon-si (KR)

(72) Inventors: Hyosuck KANG, Suwon-si (KR); Sanghyeok PARK, Suwon-si (KR); Youngseok CHO, Suwon-si (KR)

(21) Appl. No.: 17/806,038

(22) Filed: Jun. 8, 2022

Related U.S. Application Data
(63) Continuation of application No. PCT/KR2020/012325, filed on Sep. 11, 2020.

(30) Foreign Application Priority Data
Jan. 6, 2020 (KR) 10-2020-0001160

(51) Int. Cl. F25B 41/40; F25B 39/00

(52) U.S. Cl. CPC F25B 41/40; F25B 39/00

(57) ABSTRACT

A refrigerator is disclosed. The refrigerator includes a condenser, an evaporator configured to evaporate a refrigerant condensed in the condenser, capillary tubes having different sizes and configured to provide the refrigerant to the evaporator, and a connecting tube that connects the capillary tubes having different sizes to the evaporator, and the connecting tube has a guide region that is disposed between a plurality of inlets connected to the capillary tubes having different sizes, respectively.

### CROSS-REFERENCE TO RELATED APPLICATIONS

This application is a bypass continuation of International Application No. PCT/KR2020/012325, filed Sep. 11, 2020, which claims priority to Korean Patent Application No. 10-2020-0001160, filed Jan. 6, 2020, the disclosures of which are herein incorporated by reference in their entirety.

### BACKGROUND

### 1. Field

The present disclosure relates to a refrigerator and more particularly relates to a refrigerator capable of reducing noise due to refrigerant flow and improving fluidity of a refrigerant.

### 2. Description of Related Art

A refrigerator is an apparatus that supplies cold air generated by a refrigeration cycle to a storage compartment to maintain freshness of various foods for a long period of time.

In order to generate the cold air, a refrigerant is used in the refrigerator. The refrigerant repeatedly changes cross-sectional area and phase in its flow while circulating according to a refrigeration cycle, and there is a problem that the fluidity of the refrigerant is deteriorated and noise is generated during this process.

The disclosure is to solve the aforementioned problems and an object of the disclosure is to provide a refrigerator capable of reducing noise due to a refrigerant flow and improving fluidity of the refrigerant.

### SUMMARY

According to an embodiment of the disclosure for achieving the above object, there is provided a refrigerator including a condenser, an evaporator configured to evaporate a refrigerant condensed in the condenser, capillary tubes having different sizes and configured to provide the refrigerant to the evaporator, and a connecting tube that connects the capillary tubes having different sizes to the evaporator, in which the connecting tube has a guide region that is disposed between a plurality of inlets connected to the capillary tubes having different sizes, respectively.

The connecting tube may include a funnel region with an inner space that is gradually reduced and a flow region having a plurality of flow paths connected to the plurality of inlets, respectively.

The guide region may be disposed between the plurality of flow paths.

The guide region may be formed to extend towards the funnel region.

The plurality of flow paths may have cross-sectional areas corresponding to cross-sectional areas of the capillary tubes having different sizes, respectively.

The guide region may be formed so that the connecting tube is recessed in an inner side direction.

The capillary tubes having different sizes may include a first capillary tube having a predetermined size of cross-sectional area, and a second capillary tube having a cross-sectional area that is two times or more larger than the cross-sectional area of the first capillary tube.

The connecting tube and the capillary tubes having different sizes may be combined by a welding method.

The capillary tubes and the connecting tube are formed of the same material.

The refrigerator according an embodiment of the disclosure may further include a step valve configured to route the refrigerant that is condensed in the condenser to only one of the capillary tubes having different sizes.

Before undertaking the detailed description below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like;

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a perspective view schematically showing a refrigerator according to various embodiments of the present disclosure.

FIG. 2 is a diagram schematically illustrating a flow of a refrigerant in a refrigeration device in a refrigerator according to various embodiments of the present disclosure.

FIG. 3 is a perspective view illustrating a connecting tube according to various embodiments of the present disclosure.

FIG. 4 is a perspective view illustrating a connecting tube according to various embodiments of the present disclosure.

FIG. 5 is a cross-sectional view illustrating a connecting tube connected to a capillary tube and a refrigerant tube according to various embodiments of the present disclosure.

FIG. 6 is a cross-sectional view illustrating a flow of a refrigerant that passes through the connecting tube according to various embodiments of the present disclosure.

FIG. 7 is a cross-sectional view illustrating a flow of a refrigerant that passes through the connecting tube according to various embodiments of the present disclosure.

### DETAILED DESCRIPTION

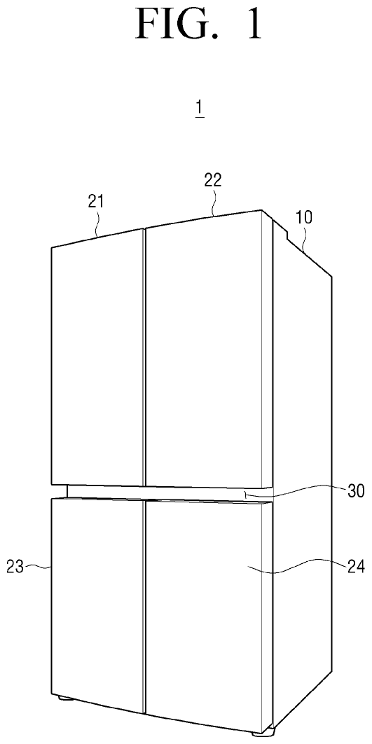

FIGS. 1 through 7, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The embodiments described hereinafter are exemplified for understanding of the disclosure and it should be understood that the disclosure may be modified and performed variously unlike in the embodiments described herein. However, in describing the disclosure, a detailed description of the related art or configuration may be omitted when it is determined that the detailed description may unnecessarily obscure a gist of the disclosure. In addition, the accompanying drawings may not be illustrated with actual scales but may be illustrated with enlarged dimensions of some elements, for the understanding of the disclosure.

The terms used in the specification and claims have been selected as general terms as possible in consideration of functions in the embodiments of the disclosure. But, these terms may vary in accordance with the intention of those skilled in the art, the precedent, technical interpretation, the emergence of new technologies and the like. In addition, there are also terms arbitrarily selected by the applicant. Such terms may be interpreted as meanings defined in this specification and may be interpreted based on general content of the specification and common technical knowledge of the technical field, if there are no specific term definitions.

In this disclosure, the terms such as “comprise”, “may comprise”, “consist of”, or “may consist of” are used herein to designate a presence of corresponding features (e.g., constituent elements such as number, function, operation, or part), and not to preclude a presence of additional features.

The expressions “first,” “second” and the like may be used for describing various elements, but the elements may not be limited by the expressions. The expressions may be used only to distinguish one element from another. For example, a first element may be referred to as a second element and the second element may also be similarly referred to as the first element, while not departing from the scope of a right of the disclosure.

In addition, the terms used in the disclosure such as “front surface”, “rear surface”, “upper surface”, “lower surface”, “side surface”, “left side”, “right side”, “upper portion”, “lower portion”, and the like are defined based on the drawings, and these terms are not for limiting a shape and a position of each constituent element.

Further, in the specification, elements necessary for describing each embodiment of the disclosure are described, and accordingly, there is no limitation thereto. Therefore, some elements may be changed or omitted and other elements may be added. In addition, the elements may be divided and disposed in different independent devices.

The embodiments of the disclosure will be described in detail with reference to the accompanying drawings and description in the accompanying drawings, but the disclosure is not limited by the embodiments.

Hereinafter, the disclosure will be described in more detail with reference to FIGS. 1 to 7.

FIG. 1 is a perspective view schematically showing a refrigerator 1 according to various embodiments of the present disclosure.

Referring to FIG. 1, the refrigerator 1 according to certain embodiments of the disclosure may include a main body 10 and doors 21, 22, 23, and 24 capable of opening and closing storage compartments.

The refrigerator 1 may be an apparatus for cooling and storing food or medicine at a predetermined temperature to prevent spoilage. The refrigerator 1 is illustrated as a shape of a typical domestic refrigerator, but is not limited thereto, and may be a Kimchi refrigerator, a beverage refrigerator, a cosmetic refrigerator, or the like.

In addition, the configuration of the disclosure is not limited to the refrigerator 1 and may also be applied to a cold water purifier, an air conditioner, a car air conditioner, and the like, as long as it uses a refrigerant.

The main body 10 may have an approximate rectangular shape with an opened front surface, but is not limited thereto, and a size and a shape thereof may be variously formed.

The main body 10 may include an outer wall forming an exterior of the refrigerator 1 and inner walls for partitioning an inner space, and the inner space of the main body may be partitioned into a plurality of storage compartments by the inner walls. Accordingly, the main body 10 may effectively accommodate food and the like in the plurality of storage compartments having various target temperatures.

The main body 10 and the doors 21, 22, 23, and 24 form an exterior of the refrigerator 1 and may be formed of a metal material to have a sense of beauty and durability.

The four doors 21, 22, 23, and 24 are illustrated, but the number of doors 21, 22, 23, and 24 is not limited thereto, and positions and shapes of the doors 21, 22, 23, and 24 may be variously arranged. The doors 21, 22, 23, and 24 may be hinge-combined with the main body 10 to be rotatable.

According to the arrangement of the doors 21, 22, 23, and 24 and the storage compartments, the refrigerator 1 may be a French door type, a side-by-side type, or the like.

A handle area 30 that is an empty space for a user to put their hands to open the doors 21, 22, 23, and 24 is included between the plurality of doors 21, 22, 23, and 24.

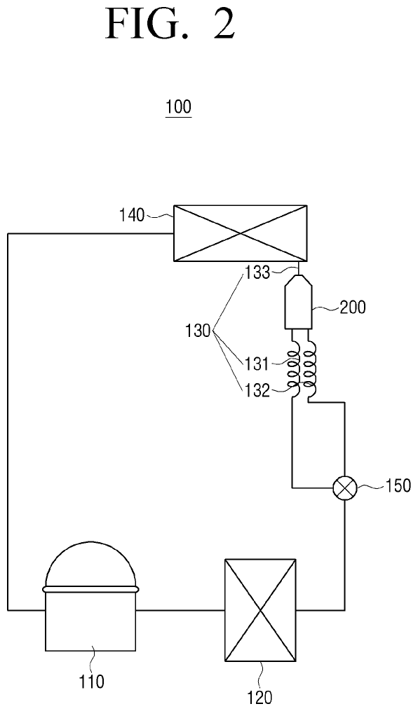

In certain embodiments, the refrigerator 1 may include a refrigeration device 100 for supplying cold air to the inside of the main body 10. The refrigeration device 100 may be a device for supplying the cold air to the inside of the main body 10 by circulating the refrigerant to in a cycle of compression, condensation, expansion, and evaporation. The specific configuration and function of the refrigeration device 100 will be described below with reference to FIG. 2.

Hereinafter, the device for making the refrigerant repeat the above jobs is referred to as the refrigeration device, but this may be variously referred to a cooling device, a refrigeration system, or the like.

FIG. 2 is a diagram schematically illustrating a flow of a refrigerant in the refrigeration device 100 in the refrigerator 1 according to various embodiments of the present disclosure.

Referring to FIG. 2, the refrigeration device 100 may include a compressor 110, a condenser 120, a capillary tube 130, and an evaporator 140. The refrigerant is a working fluid and refers to a medium that takes heat from an object at a low temperature and carries the heat to an object at a high temperature. Such a refrigerant may absorb or emit heat as the state thereof repeatedly changes while circulating through the compressor 110, the condenser 120, the capillary tube 130, and the evaporator 140.

It is illustrated that the refrigeration device 100 includes one refrigeration cycle, but there is no limitation, and a plurality of refrigeration cycles may be configured according to various target temperatures and the like of the refrigerator 1.

The compressor 110 may compress the refrigerant in a gaseous state at a low temperature and a low pressure into a gaseous state at a high temperature and a high pressure. The refrigerant that passes through the compressor may achieve a condensation pressure, which is an entry pressure of the condenser while maintaining entropy.

The condenser 120 may change a phase of the refrigerant compressed by the compressor 110 into a liquid state. In this case, the condenser 120 may be installed outdoor and emit heat of condensation to the outside according to a change of the phase of the refrigerant.

The capillary tube 130 may expand the refrigerant in a liquid state at a high temperature and a high pressure into a liquid state at a low temperature and a low pressure. As the refrigerant that has passed through the capillary tube 130 passes through the capillary tube 130 having a smaller diameter, a flow rate of the refrigerant may increase and the pressure may decrease due to a throttling effect.

The evaporator 140 may evaporate the refrigerant in the liquid state as the refrigerant in a gaseous state. In this case, the evaporator 140 may absorb latent heat of evaporation, which is necessary for the evaporation of the refrigerant. In other words, the absorption heat amount of the evaporator 140 may determine refrigeration ability of the refrigerator 1.

The capillary tube 130 may include a first capillary tube 131 and a second capillary tube 132. However, the number of capillary tubes is not limited thereto.

The first capillary tube 131 may have a diameter different from that of the second capillary tube 132. Specifically, the second capillary tube 132 may have a cross-sectional area that is two times or more larger than that of the first capillary tube 131. For example, the first capillary tube 131 may have a diameter of 0.5 mm and the second capillary tube 132 may have a diameter of 0.8 mm.

The refrigerant may be routed to only one capillary tube of the first capillary tube 131 and the second capillary tube 132 by a step valve 150. An operation method of the step valve 150 will be described below in detail.

The refrigerant tube 133 may be disposed on an entry side of the evaporator 140 and connected to the evaporator 140 by a welding method.

The step valve 150 is a valve formed using a step motor and may determine the capillary tube 130 to which the refrigerant is routed by opening and closing a plurality of tube lines selectively. Specifically, in a case where the refrigerant condensed in the condenser 120 moves to the evaporator 140, the refrigerant may be routed to only one capillary tube of the capillary tubes 130 having different sizes by the step valve 150.

For example, in an initial driving state of the refrigerator 1, the step valve 150 may open and close the tube line so that a large amount of refrigerant circulates to the capillary having a larger diameter. Accordingly, the refrigerator 1 may rapidly achieve the target temperature within a short period of time after starting driving.

In addition, in a state where a predetermined time elapses after the refrigerator 1 is driven, the step valve 150 may open and close the tube line so that a small amount of refrigerant circulates to the capillary tube having a smaller diameter. Accordingly, the refrigerator 1 may efficiently maintain the target temperature by using only a small amount of refrigerant.

The operation of the step valve 150 may be controlled by a processor. Specifically, according to whether a driving time of the refrigerator 1 exceeds a predetermined time or whether the target temperature of the refrigerator 1 is achieved, the processor may control the step valve 150 so that the refrigerant is routed to the capillary tube having a specific diameter.

However, there is no limitation thereto, and the processor may control the step valve 150 by receiving an input of the user.

The connecting tube 200 may connect the first capillary tube 131 and the second capillary tube 132 to the evaporator 140. Specifically, the refrigerant that has been routed along the first capillary tube 131 or the second capillary tube 132 may move to the evaporator through the connecting tube 200 and refrigerant tube 133.

The shape and the function of the connecting tube 200 will be described below in detail.

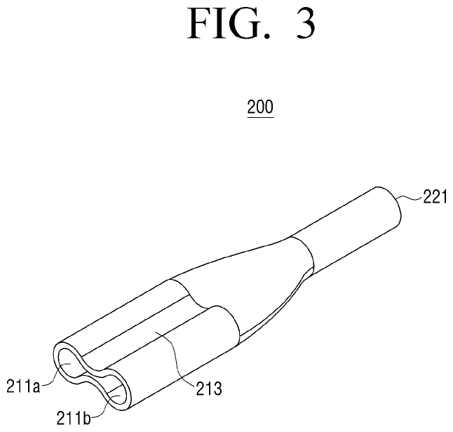

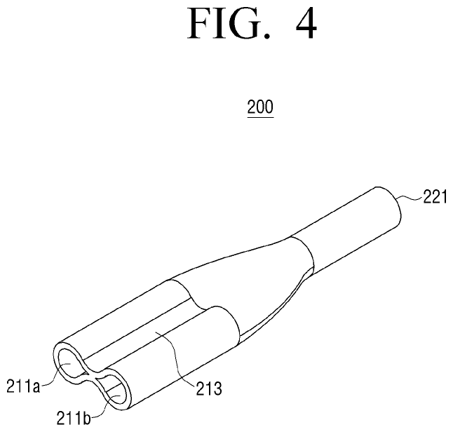

FIG. 3 is a perspective view illustrating the connecting tube 200 according to various embodiments of the present disclosure. FIG. 4 is a perspective view illustrating the connecting tube 200 according to various embodiments of the present disclosure.

Referring to FIGS. 3 and 4, the connecting tube 200 may include a first inlet 211a, a second inlet 211b, an outlet 221, and a guide region 213.

It is illustrated that the number of inlets is two, but there is no limitation, and it may be determined to be same as the number of capillary tubes connecting to an inlet side.

The refrigerant may flow into the connecting tube 200 through the inlet and the refrigerant may flow out from the connecting tube 200 through the outlet 221.

Diameters of the first inlet 211a and the second inlet 211b may be formed to correspond to the diameters of the first capillary tube 131 and the second capillary tube 132.

The guide region 213 may be formed between the first inlet 211a and the second inlet 211b. The guide region 213 may be formed so that the connecting tube 200 is recessed to an inner side direction.

Specifically, the guide region 213 may be formed by performing press work on both surfaces of the connecting tube 200 facing each other. Accordingly, both surfaces of the connecting tube 200 facing each other may be arranged to be closer to each other between the first inlet 211a and the second inlet 211b than other areas of the connecting tube 200 and may come into contact with each other in a certain region.

Referring to FIG. 3, the guide region 213 may have a recessed groove shape to the inner side direction of the connecting tube 200 between the first inlet 211a and the second inlet 211b. Accordingly, both surfaces of the connecting tube 200 facing each other may be arranged to be more adjacent to each other between the first inlet 211a and the second inlet 211b.

However, the shape of the guide region 213 is not limited thereto, and as illustrated in FIG. 4, the guide region 213 may be formed so that both surfaces of the connecting tube 200 facing each other come into contact with each other in a certain region. Accordingly, an inner space of the connecting tube 200 may be partitioned by the guide region 213.

The guide region 213 may be formed from the first inlet 211a and the second inlet 211b towards the outlet 221 by a certain section. Accordingly, a cross-sectional shape of the connecting tube 200 on the inlet side may be constant in a section where the guide region 213 is formed.

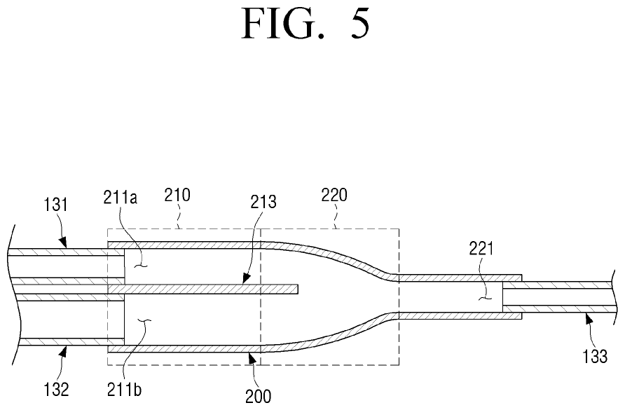

The specific shape and the function of the guide region 213 will be described below in detail with reference to FIGS. 5 to 7.

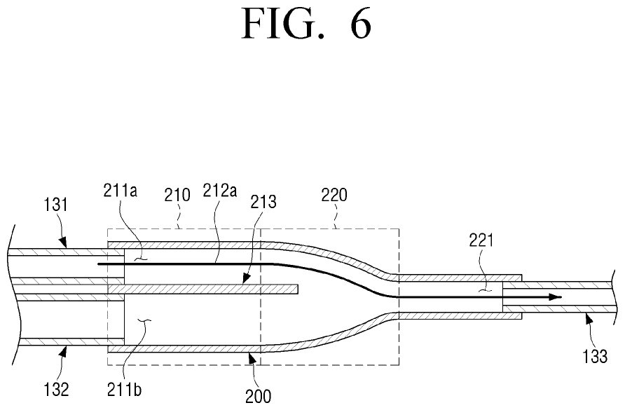

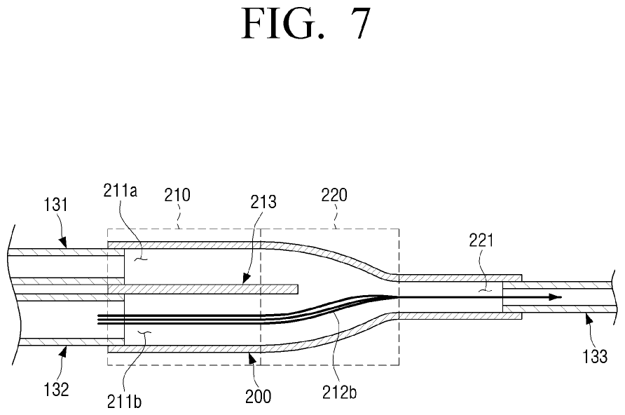

FIG. 5 is a cross-sectional view illustrating the connecting tube 200 connected to the capillary tubes 131 and 132 and the refrigerant tube 133 according to various embodiments of the present disclosure. FIG. 6 is a cross-sectional view illustrating a flow of the refrigerant that passes through the connecting tube 200 according to various embodiments of the present disclosure. FIG. 7 is a cross-sectional view illustrating a flow of the refrigerant that passes through the connecting tube 200 according to various embodiments of the present disclosure.

In order to easily describe the flow of the refrigerant in the connecting tube 200, the cross-sectional views of FIGS. 5 to 7 are illustrated to correspond to FIG. 4. However, this is merely for convenience of description and the flow of the refrigerant as in FIGS. 5 to 7 may be formed even in the connecting tube 200 having a shape of FIG. 3.

Referring to FIGS. 5 to 7, the first capillary tube 131 may be connected to the connecting tube 200 through the first inlet 211a, the second capillary tube 132 may be connected to the connecting tube 200 through the second inlet 211b, and the connecting tube 200 may be connected to the refrigerant tube 133 through the outlet 221.

As illustrated in the drawings, the plurality of capillary tubes 131 and 132 and the refrigerant tube 133 may be inserted into to the connecting tube 200. Specifically, the first capillary tube 131, the second capillary tube 132, and the refrigerant tube 133 may be inserted into the connecting tube so that each outer periphery is fit to each inner periphery of the first inlet 211a, the second inlet 211b, and the outlet 221. However, there is no limitation thereto, and the plurality of capillary tubes and the refrigerant tube 133 may be connected to the connecting tube 200 by a welding method.

For convenience of description, it is illustrated that both surfaces of the connecting tube 200 facing each other of FIGS. 5 to 7 come into contact with each other in a certain region and the inner space of the connecting tube 200 is separated by the guide region 213, but the shape of the guide region 213 is not limited thereto.

In other words, as illustrated in FIG. 3, the guide region 213 may be formed to have a recessed groove shape in the inner side direction of the connecting tube 200 in a state where regions facing each other are not in contact with each other.

The connecting tube 200 may include a flow path region 210 and a funnel region 220.

The flow path region 210 is a region where the cross-sectional area of the connecting tube 200 is constantly maintained and may have a plurality of flow paths 212 connected to the plurality of inlets 211, respectively. The funnel region 220 may be a region having a shape in that the inner space of the connecting tube 200 is gradually reduced towards the outlet 221.

Specifically, the cross-sectional area of the flow path region 210 that is constantly maintained may refer to that, not only the size of the cross-sectional area is the same, but also the cross-sectional area does not rapidly change to cause a phase change of the refrigerant.

The fluidity of the refrigerant may be improved by the shapes of the flow path region 210 and the funnel region 220 described above. This will be described below in detail with reference to FIGS. 6 and 7.

In a case where the refrigerant moves from the capillary tube 130 to the connecting tube 200, a flow cross-sectional area of the refrigerant may rapidly increase, if the connecting tube 200 does not include the guide region 213. Accordingly, a vortex flow of the refrigerant may occur inside the connecting tube 200 and the phase change according to a rapid change in pressure may occur.

In other words, the fluidity of the refrigerant that moves from the capillary tube 130 to the evaporator 140 may be deteriorated due to the vortex flow of the refrigerant, and the refrigerant may exist in a two-phase state due to the rapid phase change, thereby causing irregular refrigerant noise.

Accordingly, the connecting tube 200 according to an embodiment of the disclosure may include the guide region 213 to solve the problem described above. Referring to FIGS. 6 and 7, the fluidity of the refrigerant and the refrigerant noise improved by the connecting tube 200 including the guide region 213 will be described below in detail.

The refrigerant may flow into the connecting tube 200 from any one of the first capillary tube 131 and the second capillary tube 132 by the operation of the step valve 150 described above.

The guide region 213 may guide the refrigerant that flows from each of the capillary tubes 131 and 132 towards the outlet 221. Specifically, in the flow path region 210 of the connecting tube 200, a first flow path 212a having a cross-sectional area corresponding to the cross-sectional area of the first capillary tube 131 and a second flow path 212b having a cross-sectional area corresponding to the cross-sectional area of the second capillary tube 132 may be formed by the guide region 213.

Accordingly, even if the refrigerant moves into the connecting tube 200 from any of capillary tubes, the flow cross-sectional area of the refrigerant may not rapidly change. Therefore, the vortex flow of the refrigerant may not occur, thereby improving fluidity, and the rapid phase change of the refrigerant may not occur, thereby reducing the refrigerant noise.

The guide region 213 may be formed to extend towards the funnel region 220.

In addition, the refrigerant that has passed through the flow path region 210 may move to the outlet 221 through the funnel region 220. In such a case, the refrigerant may be smoothly guided towards the outlet 221 by the funnel region 220, the inner space of which is gradually reduced. In other words, the refrigerant moves to the outlet 221 along the shape of the funnel region 220, thereby further improving the fluidity of the refrigerant.

While preferred embodiments of the disclosure have been shown and described, the disclosure is not limited to the aforementioned specific embodiments, and it is apparent that various modifications can be made by those having ordinary skill in the technical field to which the disclosure belongs, without departing from the gist of the disclosure as claimed by the appended claims. Also, it is intended that such modifications are not to be interpreted independently from the technical idea or prospect of the disclosure.

Although the present disclosure has been described with various embodiments, various changes and modifications may be suggested to one skilled in the art. It is intended that the present disclosure encompass such changes and modifications as fall within the scope of the appended claims.

What is claimed is:

1. A refrigerator comprising:
a condenser;
an evaporator configured to evaporate a refrigerant condensed in the condenser;
capillary tubes having different sizes and configured to provide the refrigerant to the evaporator; and
a connecting tube that connects the capillary tubes having different sizes to the evaporator,
wherein the connecting tube has a guide region that is disposed between a plurality of inlets connected to the capillary tubes having different sizes, respectively.

2. The refrigerator according to claim 1, wherein:
the connecting tube comprises a funnel region with an inner space that is gradually reduced; and
a flow region having a plurality of flow paths connected to the plurality of inlets, respectively.

3. The refrigerator according to claim 2, wherein the guide region is disposed between the plurality of flow paths.

4. The refrigerator according to claim 3, wherein the guide region is formed to extend towards the funnel region.

5. The refrigerator according to claim 2, wherein the plurality of flow paths have cross-sectional areas corresponding to cross-sectional areas of the capillary tubes having different sizes, respectively.

6. The refrigerator according to claim 1, wherein the guide region is formed so that the connecting tube is recessed in an inner side direction.

7. The refrigerator according to claim 1, wherein the capillary tubes having different sizes comprises:
a first capillary tube having a predetermined size of cross-sectional area; and
a second capillary tube having a cross-sectional area that is two times or more larger than the cross-sectional area of the first capillary tube.

8. The refrigerator according to claim 1, wherein the connecting tube and the capillary tubes having different sizes are combined by a welding method.

9. The refrigerator according to claim 1, wherein the capillary tubes and the connecting tube are formed of the same material.

10. The refrigerator according to claim 1, further comprising:
a step valve configured to route the refrigerant that is condensed in the condenser to only one of the capillary tubes having different sizes.

11. A refrigerator comprising:
a main body; and
a refrigeration device configured to supply cold air to an inside of the main body, the refrigeration device including:
a compressor;
a condenser;
an evaporator configured to evaporate a refrigerant condensed in the condenser;
capillary tubes having different sizes and configured to provide the refrigerant to the evaporator; and
a connecting tube that connects the capillary tubes having different sizes to the evaporator,
wherein the connecting tube has a guide region that is disposed between a plurality of inlets connected to the capillary tubes having different sizes, respectively.

12. The refrigerator according to claim 11, wherein:
the connecting tube comprises a funnel region with an inner space that is gradually reduced; and
a flow region having a plurality of flow paths connected to the plurality of inlets, respectively.

13. The refrigerator according to claim 12, wherein the guide region is disposed between the plurality of flow paths.

14. The refrigerator according to claim 13, wherein the guide region is formed to extend towards the funnel region.

15. The refrigerator according to claim 12, wherein the plurality of flow paths have cross-sectional areas corresponding to cross-sectional areas of the capillary tubes having different sizes, respectively.

16. The refrigerator according to claim 11, wherein the guide region is formed so that the connecting tube is recessed in an inner side direction.

17. The refrigerator according to claim 11, wherein the capillary tubes having different sizes comprises:
a first capillary tube having a predetermined size of cross-sectional area; and
a second capillary tube having a cross-sectional area that is two times or more larger the cross-sectional area of the first capillary tube.

18. The refrigerator according to claim 11, wherein the connecting tube and the capillary tubes having different sizes are combined by a welding method.

19. The refrigerator according to claim 11, wherein the capillary tubes and the connecting tube are formed of the same material.

20. The refrigerator according to claim 11, further comprising:
a step valve configured to route the refrigerant that is condensed in the condenser to only one of the capillary tubes having different sizes.
